(19) United States
(12) Patent Application Publication
(10) Pub. No.: US 2026/0145505 A1
(43) Pub. Date: May 28, 2026

(54) DRIVING APPARATUS FOR ELECTRIC VEHICLES

(71) Applicants: HYUNDAI MOTOR COMPANY, Seoul (KR); KIA CORPORATION, Seoul (KR)

(72) Inventor: Seong Yeop Lim, Hwaseong-si (KR)

(73) Assignees: HYUNDAI MOTOR COMPANY, Seoul (KR); KIA CORPORATION, Seoul (KR)

(21) Appl. No.: 19/392,941

(22) Filed: Nov. 18, 2025

(30) Foreign Application Priority Data
Nov. 28, 2024 (KR) 10-2024-0174013

(51) Int. Cl. B60K 6/547; B60K 1/02; B60K 6/365; B60K 6/40; B60K 17/16

(52) U.S. Cl. CPC B60K 6/547; B60K 1/02; B60K 6/365; B60K 17/16; B60K 6/40

(57) ABSTRACT

A driving apparatus for an electric vehicle operates by combining two motors and three reduction mechanisms so that each driving region of the electric vehicle appropriately performs its role, thereby maintaining efficiency gain and effectiveness in relation to cost although required performance specifications increase or maintaining its driving efficiency at a high level.

### CROSS-REFERENCE TO RELATED APPLICATION

This application claims priority to and the benefit of Korean Patent Application No. 10-2024-0174013 filed on Nov. 28, 2024, in the Korean Intellectual Property Office, the entire contents of which are incorporated herein by reference.

### FIELD

The present disclosure relates to a driving apparatus for an electric vehicle.

### BACKGROUND

In general, a driving apparatus for electric vehicles (commonly called e-Axle, hereinafter referred to as driving apparatus) require high efficiency, high performance (torque and output improvement), and low-cost design and production within a limited installation space, and depending on whether it is applied as the main drive source in a two-wheel drive (2WD) or four-wheel drive (4WD) electric vehicle, or as an auxiliary drive source in a four-wheel drive (4WD) electric vehicle, it is equipped with a high-cost high-efficiency motor system and a low-cost low-efficiency or non-rare-earth element motor system.

In cases where such driving apparatus is applied as the main driving source, it is configured as a single driving platform under the condition that satisfies the mountability while focusing on low cost along with high efficiency for improving the travel distance and fuel efficiency of the electric vehicle, and responds to a plurality of required performance specifications by changing only some of the design specifications.

In the case where a driving apparatus implemented with a motor equipped with rare-earth element permanent magnets requires addition or improvement of hill climbing and towing ability in addition to the basic required performance, a change in the overall design of the reduction mechanism, motor, and electric power converter in the conventional driving apparatus is inevitable, and this causes a problem in that the efficiency gain and effect are lowered compared to the investment cost.

The information contained in this Background section is intended to promote understanding of the background of the invention and may include matters that are not conventional art already known to a person having ordinary skill in the art to which this technology belongs.

### SUMMARY

The present disclosure provides a driving apparatus for an electric vehicle capable of responding to various driving regions by combining two motors and three reduction mechanisms.

In addition, the present disclosure provides a driving apparatus for an electric vehicle that can maintain efficiency gain and effectiveness in terms of cost or maintain its driving efficiency at a high level even if the performance specifications required for implementation of the present disclosure are changed.

In an embodiment of the present disclosure, a driving apparatus for an electric vehicle includes: a first motor arranged on both sides of a drive shaft, which connects a differential to wheels and transmits driving torque to the wheels, wherein the first motor includes a first motor shaft of a hollow shaft arranged to overlap the drive shaft. The driving apparatus further includes a second motor arranged parallel to the first motor and including a second motor shaft, an output shaft coaxially arranged with the second motor shaft of the second motor, an idle shaft arranged parallel between the first motor shaft of the first motor and the second motor shaft of the second motor. The driving apparatus further includes a first reduction mechanism including a first output gear fixed to the first motor shaft, a second output gear on the output shaft, and a first idle gear fixed to one side of the idle shaft and externally engaged with the first and second output gears. The driving apparatus further includes a second reduction mechanism including a second idle gear fixed to the other side of the idle shaft and a differential ring gear of the differential which is externally engaged with the second idle gear. The driving apparatus further includes a third reduction mechanism including a first planetary gear set having first, second, and third rotation elements and arranged on the second motor shaft, and reducing the rotation speed of the torque input from the second motor and outputting the rotation speed of the torque input to the output shaft. The driving apparatus further includes a power disconnection device interposed between the first reduction mechanism and the third reduction mechanism and configured to selectively connect the torque of the second motor transmitted from the third reduction mechanism to the first reduction mechanism.

The second output gear may be fixed to a first side of the output shaft, and the output shaft may be selectively connected to an output side of the third reduction mechanism through the power disconnection device.

The first rotation element may be connected to the second motor shaft and configured to operate as an input element, the second rotation element may be selectively connected to the output shaft and configured to operate as an output element, and the third rotation element may be fixedly attached to a housing and configured to operate as a fixed element.

The first planetary gear set may be a single pinion planetary gear set including a first sun gear, which is the first rotation element, a first planetary carrier, which is the second rotation element, and a first ring gear, which is the third rotation element.

The power disconnection device may be disposed on the output shaft and is configured to selectively connect the output shaft to the second rotation element of the first planetary gear set.

The driving apparatus may further include a middle shaft disposed on the output shaft which is disposed between the first reduction mechanism and the third reduction mechanism and connected to an output side of the third reduction mechanism, and a transmission device, which is a second planetary gear set disposed on the middle shaft, including fourth, fifth, and sixth rotation elements, and selectively shifting an input torque through the third reduction mechanism from the second motor into two shift stages.

The fourth rotation element may be connected to the middle shaft and operate as an input element, the fifth rotation element may be selectively connected to the output shaft through the power disconnection device and operate as an output element, and the sixth rotation element may be selectively connected to between the fourth rotation element and a housing and operate as the input element or a fixed element.

The transmission device may further include a clutch interposed between the fourth rotation element and the sixth rotation element and selectively connecting the fourth rotation element to the sixth rotation element, and a brake interposed between the sixth rotation element and the housing to selectively connect the sixth rotation element to the housing.

The second planetary gear set may be a single pinion planetary gear set including a second sun gear, which is the fourth rotation element, a second planetary carrier, which is the fifth rotation element, and a second ring gear, which is the sixth rotation element.

The fourth rotation element may be connected to the middle shaft and operate as an input element, the fifth rotation element may be selectively connected to the output shaft and operate as an output element, and the sixth rotation element may be selectively connected to between the fifth rotation element and a housing and operate as the input element or a fixed element.

The transmission device may further include a clutch disposed between the fifth rotation element and the sixth rotation element to and configured to selectively connect the fifth rotation element to the sixth rotation element, and a brake disposed between the sixth rotation element and the housing and configured to selectively connect the sixth rotation element to the housing.

The second planetary gear set may be a double pinion planetary gear set including a second sun gear which is the fourth rotation element, a second ring gear which is the fifth rotation element, and a second planetary carrier which is the sixth rotation element.

The driving apparatus may further include an engine connected to the sixth rotation element of the transmission device through an engine output shaft.

The output shaft may be fixedly connected to the output side of the third reduction mechanism, the second output gear may be rotatably arranged on one side of an output shaft and the output shaft may be selectively connected to the second output gear through the power disconnection device.

The first rotation element may be connected to the second motor shaft and operate as an input element, the second rotation element may be connected to the output shaft and operate as an output element, and the third rotation element may be fixedly attached to a housing and operate as a fixed element.

The power disconnection device may be disposed between the output shaft and the second output gear to selectively connect the output shaft to the second output gear.

The driving apparatus may further include a middle shaft arranged through the output shaft which is formed as a hollow shaft and connected to the output side of the third reduction mechanism, and a transmission device as a second planetary gear set including fourth, fifth, sixth rotation elements and coaxially arranged with the middle shaft on an opposite side of the third reduction mechanism with the first reduction mechanism as reference.

The fourth rotation element may be connected to the middle shaft and operate as an input element, the fifth rotation element may be selectively connected to the output shaft and operate as an output element, and the sixth rotation element may be selectively connected to between the fourth rotation element and the housing and operate as the input element or a fixed element.

The sixth rotation element may be connected to the middle shaft and operate as an input element, the fifth rotation element may be selectively connected to the output shaft and operate as an output element, and the fourth rotation element may be selectively connected to between the fifth rotation element and the housing and operate as the input element or a fixed element.

The driving apparatus may further include an engine connected to the fourth rotation element of the transmission device through an engine output shaft.

It is to be understood that both the foregoing general description and the following detailed description are exemplary and explanatory and are intended to provide further explanation of the disclosure as claimed.

### BRIEF DESCRIPTION OF THE DRAWINGS

These drawings are intended for reference in explaining various disclosure and therefore should not be interpreted as limiting the technical ideas of the present disclosure to the accompanying drawings.

FIG. 1 is a schematic diagram of a driving apparatus for an electric vehicle according to the first embodiment of the present disclosure.

FIG. 2 is a schematic diagram of a driving apparatus for an electric vehicle according to the second embodiment of the present disclosure.

FIG. 3 is a schematic diagram of a driving apparatus for an electric vehicle according to the third embodiment of the present disclosure.

FIG. 4 is a schematic diagram of a driving apparatus for an electric vehicle according to the fourth embodiment of the present disclosure.

FIG. 5 is a schematic diagram of a driving apparatus for an electric vehicle according to the fifth embodiment of the present disclosure.

FIG. 6 is a schematic diagram of a driving apparatus for an electric vehicle according to the sixth embodiment of the present disclosure.

FIG. 7 is a schematic diagram of a driving apparatus for an electric vehicle according to the seventh embodiment of the present disclosure.

FIG. 8 is a schematic diagram of a driving apparatus for an electric vehicle according to the eighth embodiment of the present disclosure.

FIG. 9 is a schematic diagram of a driving apparatus for an electric vehicle according to the ninth embodiment of the present disclosure.

FIG. 10 is a schematic diagram of a driving apparatus for an electric vehicle according to the tenth embodiment of the present disclosure.

FIG. 11 is a schematic diagram of a driving apparatus for an electric vehicle according to the eleventh embodiment of the present disclosure.

FIG. 12 is a schematic diagram of a driving apparatus for an electric vehicle according to the twelfth embodiment of the present disclosure.

It should be understood that the drawings referenced above are not necessarily drawn to scale, but rather present rather simplified representations of various preferred features illustrating the basic principles of the present disclosure. For example, specific design features of the present disclosure, including specific dimensions, orientations, locations, and shapes, will be determined in part by the particular intended application and usage environment.

### DETAILED DESCRIPTION

Hereinafter, embodiments disclosed in this specification will be described in detail with reference to the attached drawings. The same or similar components are given the same or similar drawing reference numerals, and redundant descriptions thereof are omitted.

In describing the embodiments disclosed in this specification, if it is determined that a detailed description of a related known technology may obscure the gist of the embodiments disclosed in this specification, the detailed description is omitted. In addition, the attached drawings are only intended to facilitate easy understanding of the embodiments disclosed in this specification, and the technical ideas disclosed in this specification are not limited by the attached drawings, but should be understood to include all modifications, equivalents, or substitutes included in the spirit and technical scope of the present disclosure.

Terms including ordinal numbers, such as first, second, etc., may be used to describe various components, but the components are not limited by the terms. The above terms are used solely to distinguish one component from another.

When a component is said to be “connected” or “combined” to another component, it should be understood that it may be directly connected or combined to that other component, but there may also be other components in between. On the other hand, when a component is said to be “directly connected” or “directly combined” to another component, it should be understood that there are no other components in between.

In this application, terms such as “include” or “have” should be understood to specify the presence of a feature, number, step, operation, component, part or combination thereof described in the specification, but not to exclude in advance the possibility of the presence or addition of one or more other features, numbers, steps, operations, components, parts or combinations thereof.

Terms such as “-unit”, “-portion”, “-part”, “-module”, and “-means” described in the specification are assigned or used interchangeably only for the convenience of writing the specification, and do not have distinct meanings or roles in themselves. Additionally, terms such as “-unit”, “-portion”, “-part”, “-module”, and “-means” described in the specification may mean a unit that processes at least one function or operation, which may be implemented by hardware, software, or a combination of hardware and software.

The terminology used herein is for the purpose of describing particular embodiments only and is not to be limiting of the embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this disclosure, specify the presence of stated features, integers, operations, operations, elements, components or a combination thereof, but do not preclude the presence or addition of one or more other features, integers, operations, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As used herein, the singular forms are intended to include the plural forms as well, unless the context clearly indicates otherwise. As used herein, the term “and/or” includes any one or all combinations of the associated listed items.

Hereinafter, one or more embodiments of the present disclosure are described in more detail with reference to the accompanying drawings.

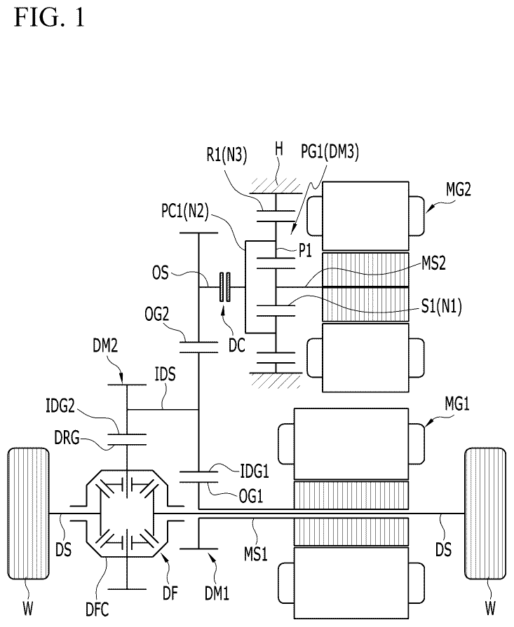

FIG. 1 is a schematic diagram of a driving apparatus for an electric vehicle according to the first embodiment of the present disclosure.

Referring to FIG. 1, a driving apparatus for an electric vehicle according to the first embodiment of the present disclosure (hereinafter, referred to as driving apparatus) may include a first motor MG1, a second motor MG2, an output shaft OS, an idle shaft IDS, first, second, third reduction mechanisms DM1, DM2, and DM3, and a power disconnection device DC.

The driving apparatus according to the first embodiment of the present disclosure may be driven by two motors including the first motor MG1 and the second motor MG2.

The first and second motors MG1 and MG2 may perform motor and generator functions respectively, and each of the first and second motors MG1 and MG2 may include a stator fixed to the housing and a rotor rotatably supported in the radial direction, and in the first embodiment of the present disclosure, may perform the function of a driving motor as their main function.

The driving apparatus according to the first embodiment of the present disclosure may include a differential DF. The differential DF and both wheels W may be connected to enable power delivery through a drive shaft DS, respectively.

The first motor MG1 may be disposed on one of the drive shafts DS on both sides, which transmit driving torque to the wheels W on both sides.

The first motor MG1 may include a first motor shaft MS1, which is a hollow shaft, and the first motor shaft MS1 may be arranged to overlap one side drive shaft DS without rotation interference. In particular, one side drive shaft DS may be arranged to penetrate through the first motor MG1 and the first motor shaft MS1.

The second motor MG2 may be arranged parallel to the first motor MG1.

The output shaft OS may be coaxially arranged with a second motor shaft MS2 of the second motor MG2.

The idle shaft IDS may be arranged parallel between the first motor shaft MS1 of the first motor MG1 and the second motor shaft MS2 of the second motor MG2.

The first reduction mechanism DM1 may be a gear train including a first output gear OG1 fixed to the first motor shaft MS1, a second output gear OG2 on the output shaft OS, and a first idle gear IDG1 fixed to one side of the idle shaft IDS and externally engaged with the first and second output gears OG1, and OG2, respectively.

In the first embodiment of the present disclosure, the second output gear OG2 may be fixed to one side of the output shaft OS.

The second reduction mechanism DM2 may include a second idle gear IDG2 fixed to the other side of the idle shaft IDS and a differential ring gear DRG of a differential DF externally engaged with the second idle gear IDG2.

The third reduction mechanism DM3 may be a first planetary gear set PG1 having first, second, and third rotation elements N1, N2, and N3 and arranged on the second motor shaft MS2. The third reduction mechanism DM3 may be configured to reduce the speed of the torque input from the second motor MG2 and output the speed of the torque input to the output shaft OS.

In the third reduction mechanism DM3, the first rotation element N1 may be connected to the second motor shaft MS2 and may operate as an input element, the second rotation element N2 may be selectively connected to the output shaft OS and operate as an output element, and the third rotation element N3 may be fixed to the housing H and operate as a fixed element.

The first planetary gear set PG1, which is the third reduction mechanism DM3, may be a single pinion planetary gear set and include a first sun gear S1, which is the first rotation element N1, a first planetary carrier PC1, which is the second rotation element N2 and supports rotation and revolution of a plurality of first pinion gears P1 that are externally engaged radially equally spaced on the exterior circumference of the first sun gear S1, and a first ring gear R1, which is the third rotation element N3, internally engaged with a plurality of first pinion gears P1 and is power-connected to the first sun gear S1.

The power disconnection device DC may be interposed between the first reduction mechanism DM1 and the third reduction mechanism DM3 and selectively connects the torque of the second motor MG2 transmitted from the third reduction mechanism DM3 to the first reduction mechanism DM1.

The power disconnection device DC may be arranged between the output shaft OS and the second rotation element N2 of the first planetary gear set PG1 to selectively connect the output shaft OS and the second rotation element N2.

The power disconnection device DC may include a multi-plate clutch operated by hydraulic pressure supplied from a hydraulic pressure control apparatus, and mainly a wet multi-plate clutch may be applied, but a dry multi-plate clutch may also be applied. A coupling element operated based on the electrical signal supplied from the electric control apparatus, such as a dog clutch, an electronic clutch, a self-distributing clutch, a one-way clutch or a synchronizer, may also be applied.

In the first embodiment of the present disclosure, the second output gear OG2 may be fixed to one side of the output shaft OS, and the output shaft OS may be configured to be selectively connected to the second rotation element N2, which is the output side of the third reduction mechanism DM3, through the power disconnection device DC.

When the second motor MG2 drives, the torque may be input to the first rotation element N1 of the first planetary gear set PG1, which is the third reduction mechanism DM3, through the second motor shaft MS2, and the rotation speed may be reduced and output through the second rotation element N2. The power disconnection device DC may selectively transmit the torque of the second motor MG2, whose speed is reduced through the second rotation element N2, to the output shaft OS.

The driving apparatus according to the first embodiment of the present disclosure may form an integrated driving system in which the first and second motors MG1 and MG2, the output shaft OS, the idle shaft IDS, the first, second, third reduction mechanisms DM1, DM2, and DM3, the power disconnection device DC, and a separate electric power converter (not shown) are mounted in the housing H.

The first and second motors MG1 and MG2 may be applied with different types of motors, such as a motor with a rare earth element permanent magnet or a motor with a non-rare earth element permanent magnet, or with different specifications of the same type with a relative difference in the maximum rotation speed of at least about 5,000 RPM.

The stacking length of the second motor MG2 may be designed so as not to exceed the stacking length of the first motor MG1, and even if it exceeds it, it may be designed so as to satisfy the loadability of the driving apparatus or not to affect the axial direction length (overall length) of the driving apparatus.

According to the first embodiment of the present disclosure, when the first motor MG1 is driven, the torque may be input to the first idle gear IDG1 through the first output gear OG1 of the first reduction mechanism DM1 via the first motor shaft MS1, and the rotation speed may be reduced and transmitted to the idle shaft IDS.

The torque transmitted to the idle shaft IDS at reduced speed may be transmitted to a differential ring gear DRG fixed to a differential case DFC of the differential DF through the second idle gear IDG2.

The differential DF may absorb the difference in rotation speed of the wheels W on both sides and transmit driving torque to the wheels W on both sides through the drive shafts DS on both sides.

When the second motor MG2 is driven, the torque may be input to the first rotation element N1 of the first planetary gear set PG1, which is the third reduction mechanism DM3, through the second motor shaft MS2, and the speed may be reduced and output through the second rotation element N2.

When the power disconnection device DC is operated, the torque of the second motor MG2, whose speed is reduced and output through the second rotation element N2, may be transmitted to the output shaft OS, and the speed may be reduced and transmitted to the first idle gear IDG1 through the second output gear OG2.

The torque of the second motor MG2 may increase with the torque of the first motor MG1 and may be transmitted to the idle shaft IDS, and the torque transmitted to the idle shaft IDS may be transmitted to the differential ring gear DRG of the differential DF through the second idle gear IDG2.

The differential DF may absorb the difference in rotation speed of the wheels W on both sides and transmit the driving torque of the first and second motors MG1 and MG2 to the wheels W on both sides through the drive shafts DS on both sides.

The driving apparatus may operate only the first motor MG1 in the travel distance or fuel economy driving region to enable high efficiency driving, and in the high load driving region, the first, second motors MG1, and MG2 may be simultaneously operated to supplement the insufficient torque and output of the wheels by the first motor MG1 with the torque and output by the second motor MG2.

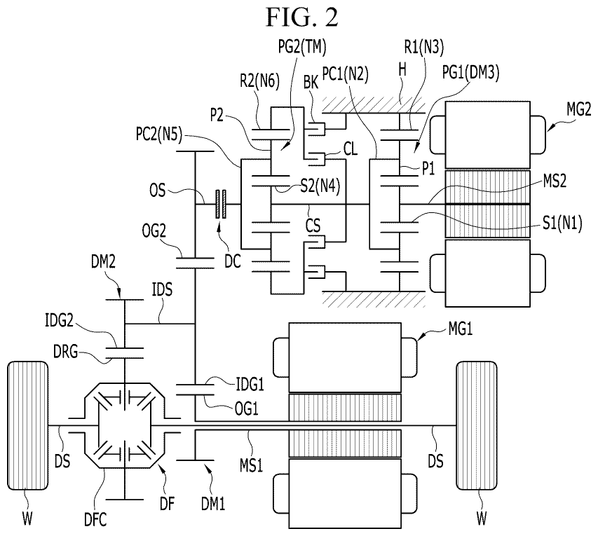

FIG. 2 is a schematic diagram of a driving apparatus for an electric vehicle according to the second embodiment of the present disclosure.

For convenience of understanding, when describing a driving apparatus for an electric vehicle according to a second embodiment of the present disclosure, the same components as those described above according to the driving apparatus for an electric vehicle according to the first embodiment of the present disclosure is denoted by the same reference numerals. In addition, when explaining the driving apparatus for an electric vehicle according to the second embodiment of the present disclosure, an overlapped explanation of the configuration and operation of the same components as those of the driving apparatus for an electric vehicle according to the first embodiment of the present disclosure is omitted.

Referring to FIG. 2, the driving apparatus according to the second embodiment of the present disclosure may have a difference in that a middle shaft CS is added compared to the first embodiment, and a transmission device TM is additionally configured on the middle shaft CS.

The driving apparatus according to the first embodiment of the present disclosure may be configured such that the third reduction mechanism DM3 selectively transmits the torque of the second motor MG2 to the output shaft OS through the power disconnection device DC.

On the other hand, the driving apparatus according to the second embodiment of the present disclosure may further include a transmission device TM that selectively shifts the torque of the second motor MG2, whose rotation speed is reduced and output from the third reduction mechanism DM3, into two shift stages and outputs the shifted torque, and the shifted torque may be selectively transmitted to the output shaft OS through the power disconnection device DC.

The middle shaft CS may be coaxially arranged with the output shaft OS between the first reduction mechanism DM1 and the third reduction mechanism DM3 and may be connected to the second rotation element N2, which is the output side of the third reduction mechanism DM3.

The transmission device TM may be a second planetary gear set PG2 including fourth, fifth, sixth rotation elements N4, N5, and N6 and coaxially arranged with the middle shaft CS. The transmission device TM may be configured to selectively shift the input torque through the third reduction mechanism DM3 from the second motor MG2 into two shift stages and output the input torque to the output shaft OS.

In the transmission device TM, the fourth rotation element N4 may be connected to the middle shaft CS and operate as an input element, the fifth rotation element N5 may be selectively connected to the output shaft OS through the power disconnection device DC and operates as an output element, and the sixth rotation element N6 may be selectively connected to the fourth rotation element N4 or housing H and operate as an input element or a fixed element.

The second planetary gear set PG2 of the transmission device TM may be a single pinion planetary gear set and may include a second sun gear S2 as the fourth rotation element N4, a second planetary carrier PC2 as the fifth rotation element N5 that supports rotation (or revolution) of a plurality of second pinion gears P2 that are externally engaged radially and equally spaced on an exterior circumference side of the second sun gear S2, and a second ring gear R2 as the sixth rotation element N6 that is internally engaged with a plurality of second pinion gear P2 and is power-connected to the second sun gear S2.

The transmission device TM may include a clutch CL interposed between the second sun gear S2, which is the fourth rotation element N4, and the second ring gear R2, which is the sixth rotation element N6, to selectively connect the fourth rotation element N4 and the sixth rotation element N6, and a brake BK interposed between the sixth rotation element N6 and the housing H to selectively connect the sixth rotation element N6 to the housing H.

The clutch CL may interconnect the fourth rotation element N4 and the sixth rotation element N6 so that the second planetary gear set PG2 itself may rotate as a single rotation body, and the brake BK may fix the sixth rotation element N6 so that the second ring gear R2 may act as a fixed element.

The driving apparatus according to the second embodiment of the present disclosure may differ from the first embodiment in that the middle shaft CS and the transmission device TM may be additionally configured, but all other components and the connection relationships between each component are the same as those in the first embodiment, so a detailed description of the configuration is omitted.

In the driving apparatus according to the second embodiment of the present disclosure, in the travel distance or fuel economy driving region, the power disconnection device DC may be released to block the power delivery path to the second motor MG2 and only the first motor MG1 may be operated to enable high efficiency driving. In addition, in the high-load operation region, the first and second motors MG1 and MG2 may be simultaneously operated with the power disconnection device DC engaged so that the insufficient torque and output of the wheel by the first motor MG1 can be supplemented by the torque and output by the second motor MG2.

The transmission device TM can implement a first speed gear shift that provides greater torque by engaging the brake BK while releasing the clutch CL when greater torque is required from the second motor MG2, thereby reducing the speed of the torque output to the output shaft OS. In addition, by engaging the clutch CL while releasing the brake BK, the second planetary gear set PG2 itself can be operated as a single rotating body, thereby implementing a second speed gear shift in which the torque is output as input.

The brake BK and the clutch CL may include a multi-plate clutch operated by hydraulic pressure supplied from a hydraulic pressure control apparatus, and mainly a wet multi-plate clutch is applied, but a dry multi-plate clutch can also be applied. And a coupling element operated according to the electrical signal supplied from the electric control apparatus, such as a dog clutch, an electronic clutch, a self-distributing clutch, a one-way clutch or a synchronizer, can also be applied.

According to the second embodiment, when the driving apparatus is applied as the driving apparatus on the main driving wheel side in a four-wheel drive (4WD) electric vehicle and the driving condition is a two-wheel drive (2WD), or when the driving apparatus is applied as the driving apparatus on the auxiliary driving wheel side and the driving condition is a low-load four-wheel drive (4WD), the power disconnection device DC is released to remove the no-load drag (loss) to the wheels generated from the second motor MG2, and to enable immediate response driving using only the torque and output of the first motor MG1.

On the other hand, when the driving apparatus is applied to the main or auxiliary driving wheel side and is in a constant four-wheel drive (4WD) driving condition or a four-wheel drive (4WD) driving condition of a medium load or higher, the first and second motors MG1 and MG2 may be simultaneously operated with the power disconnection device DC engaged so that the insufficient torque and output of the wheel by the first motor MG1 may be supplemented by the torque and output by the second motor MG2.

For example, the transmission mechanism TM may respond by implementing the first speed gear shift in driving conditions that require greater torque from the second motor MG2, such as starting at low speeds, and hill climbing and towing, and may respond by implementing the second speed gear shift in driving conditions that require the highest vehicle speed performance, such as overtaking and acceleration.

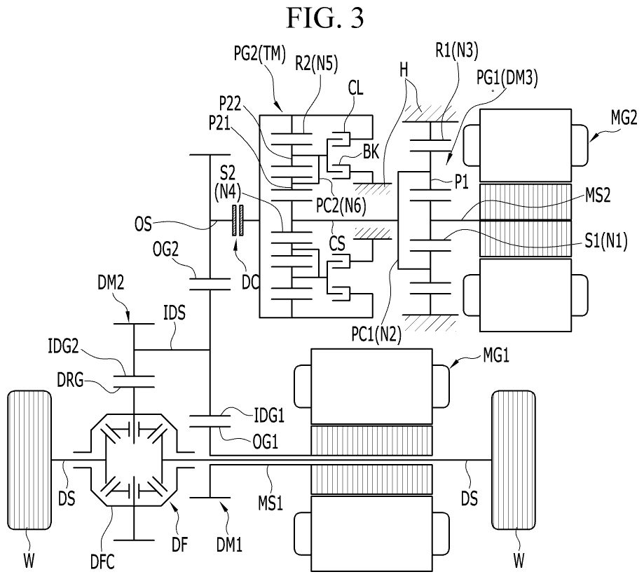

FIG. 3 is a schematic diagram of a driving apparatus for an electric vehicle according to the third embodiment of the present disclosure.

For convenience of understanding, when describing a driving apparatus for an electric vehicle according to the third embodiment of the present disclosure, the same components as those described above according to the driving apparatus for an electric vehicle according to the second embodiment of the present disclosure is denoted by the same reference numerals. In addition, when explaining the driving apparatus for an electric vehicle according to the third embodiment of the present disclosure, a overlapped explanation of the configuration and operation of the same components as those of the driving apparatus for an electric vehicle according to the second embodiment of the present disclosure is omitted.

Referring to FIG. 3, the driving apparatus according to the third embodiment of the present disclosure may have a difference in the configuration of the second planetary gear set PG2 applied to the transmission device TM compared to the second embodiment.

The driving apparatus according to the second embodiment of the present disclosure may be applied with the second planetary gear set PG2 applied to the transmission device TM as a single pinion planetary gear set. However, the driving apparatus according to the third embodiment of the present disclosure may have a difference in that the second planetary gear set PG2 applied to the transmission device TM is applied as a double pinion planetary gear set.

The transmission device TM applied to the driving apparatus according to the third embodiment of the present disclosure may include a second planetary gear set PG2 formed by a double pinion planetary gear set and having fourth, fifth, sixth rotation elements N4, N5, and N6, coaxially arranged with the middle shaft CS, and configured to selectively shift the torque of the second motor MG2, whose rotation speed is reduced and output from the third reduction mechanism DM3, into two shift stages and outputs the shifted torque, and the shifted torque may be selectively transmitted to the output shaft OS through the power disconnection device DC.

The fourth rotation element N4 may be connected to the middle shaft CS and operate as an input element, the fifth rotation element N5 may be selectively connected to the output shaft OS and operate as an output element, and the sixth rotation element N6 may be selectively connected to between the fifth rotation element N5 and housing H and operates as an input element or a fixed element.

The second planetary gear set PG2 of the transmission device TM as a double pinion planetary gear set may include a second sun gear S2 as the fourth rotation element N4, a second ring gear R2 as the fifth rotation element N5 arranged on an exterior circumference side of the second sun gear S2, and a second planetary carrier PC2 as the sixth rotation element N6 that supports rotation and revolution of a plurality of second double pinion gears P21 and P22 that are equally spaced between the second sun gear S2 and the second ring gear R2 and are externally and internally engaged with the second sun gear S2 and the second ring gear R2, respectively.

The transmission device TM may include a clutch CL interposed between the second ring gear R2, which is the fifth rotation element N5, and the second planetary carrier PC2, which is the sixth rotation element N6, to selectively connect the fifth rotation element N5 and the sixth rotation element N6, and a brake BK interposed between the sixth rotation element N6 and the housing H to selectively connect the sixth rotation element N6 to the housing H.

The clutch CL may interconnect the fifth rotation element N5 and the sixth rotation element N6 so that the second planetary gear set PG2 itself rotates as a single rotation body, and the brake BK may connect the sixth rotation element N6 so that it acts as a fixed element.

The driving apparatus according to the third embodiment of the present disclosure may differ only in the configuration of the transmission device TM compared to the second embodiment, and all other components and the connection relationship and operation of each component are the same as the second embodiment, so overlapped detailed configuration and operation descriptions are omitted.

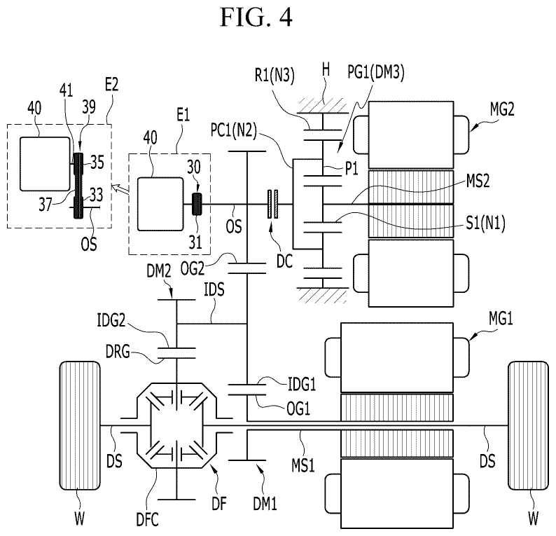

FIG. 4 is a schematic diagram of a driving apparatus for an electric vehicle according to the fourth embodiment of the present disclosure.

For convenience of understanding, when describing a driving apparatus for an electric vehicle according to the fourth embodiment of the present disclosure, the same components as those described above according to the driving apparatus for an electric vehicle according to the first embodiment of the present disclosure is denoted by the same reference numerals. In addition, when explaining the driving apparatus for an electric vehicle according to the fourth embodiment of the present disclosure, a overlapped explanation of the configuration and operation of the same components as those of the driving apparatus for an electric vehicle according to the first embodiment of the present disclosure is omitted.

Referring to FIG. 4, the driving apparatus according to the fourth embodiment of the present disclosure may have a difference compared to the first embodiment in that an air conditioning compressor 40 capable of being power-connected to the output shaft OS through a power connector 30 is added.

The power connector 30 may be configured as a normally open type electronic clutch 31 that enables power connection between the output shaft OS and the rotation shaft 41 of the compressor 40, as an example E1. As another example E2, the power connector 30 may be formed by an electronic belt pulley apparatus 39 that connects a driving pulley 33 configured on the output shaft OS and a driven pulley 35 configured on a rotation shaft 41 of the compressor 40 with a belt 37.

When the electronic clutch 31 or the electronic belt pulley apparatus 39 is applied to the power connector 30, the torque of the second motor MG2 may be connected or blocked to the compressor 40 by operating based on the electrical signal supplied from the electronic control apparatus.

The driving apparatus according to the fourth embodiment of the present disclosure may differ from the first embodiment in that the air conditioning compressor 40 is added, but all other components and the connection relationships between each component are the same as the second embodiment, so a detailed description of the configuration is omitted.

The air conditioning compressor 40 may provide optimal air conditioning performance by utilizing the torque of the second motor MG2 when the vehicle is stopped, driving, charging, or at the P signal position of the shift lever.

The compressor 40 may be configured to operate in the region where the rotation speed and output torque of the second motor MG2 are optimal when the power disconnector 10 is turned off, but does not rotate to a high rotation speed corresponding to the maximum vehicle speed, so that it can be configured as a relatively low-cost type without high performance, and a variable capacity type or electron clutch type compressor that can be adjusted by the existing driver can be applied.

In the driving apparatus for an electric vehicle applied as a main or auxiliary driving source, even when the vehicle is stopped, charged, or driven at low speed, if there is a demand for operation of the compressor 40, the power disconnection device DC may be always maintained in an operating state, and the compressor 40 may be driven by the torque of the second motor MG2 to provide optimal air conditioning performance.

Meanwhile, during normal driving excluding the driving conditions above, if the required driving torque of the vehicle requires the driving torque of the second motor MG2, and the sum of the converted output torque of the second motor MG2 required as the required driving torque of the vehicle and the driver torque of the compressor 40 may be less than the maximum output torque of the second motor MG2 while power disconnection device DC is operating, the driving performance of the vehicle may be secured by the sum of the required driving torque of the second motor MG2, and at the same time, the compressor 40 may be normally operated by the residual driving torque of the second motor MG2 at the rotation speed corresponding to the vehicle speed.

If the sum of the converted output torque of the second motor MG2 required as the required driving torque of the vehicle and the driver torque of the compressor 40 may exceed the maximum output torque of the second motor MG2, or if the required driving torque of the vehicle requires almost all of the converted output torque of the second motor MG2, the compressor 40 may be operated at the lowest performance level to secure the driving performance of the vehicle as a top priority, or the operation of the compressor 40 may be stopped by electronically controlling the power connector 30.

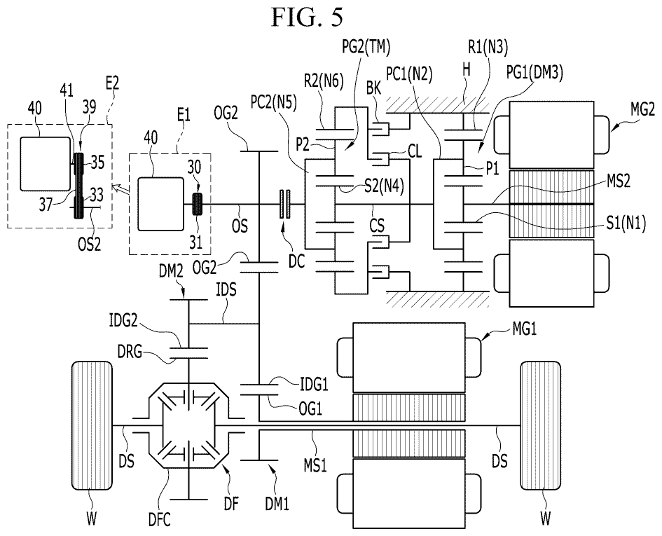

FIG. 5 is a schematic diagram of a driving apparatus for an electric vehicle according to the fifth embodiment of the present disclosure.

For convenience of understanding, when describing a driving apparatus for an electric vehicle according to the fifth embodiment of the present disclosure, the same components as those described above according to the driving apparatus for an electric vehicle according to the second embodiment of the present disclosure is denoted by the same reference numerals. In addition, when explaining the driving apparatus for an electric vehicle according to the fifth embodiment of the present disclosure, an overlapped explanation of the configuration and operation of the same components as those of the driving apparatus for an electric vehicle according to the second embodiment of the present disclosure is omitted.

Referring to FIG. 5, the driving apparatus according to the fifth embodiment of the present disclosure may have a difference compared to the second embodiment in that an air conditioning compressor 40 capable of being power-connected to the output shaft OS through a power connector 30 is added.

The power connector 30 may be configured as a normally open type electronic clutch 31 that enables power connection between the output shaft OS and the rotation shaft 41 of the compressor 40, as an example E1. As another example E2, the power connector 30 may be formed by an electronic belt pulley apparatus 39 that connects a driving pulley 33 configured on the output shaft OS and a driven pulley 35 configured on a rotation shaft 41 of the compressor 40 with a belt 37.

When the electronic clutch 31 or the electronic belt pulley apparatus 39 is applied to the power connector 30, the torque of the second motor MG2 may be connected or blocked to the compressor 40 by operating according to the electrical signal supplied from the electronic control apparatus.

The driving apparatus according to the fifth embodiment of the present disclosure may differ from the second embodiment in that an air conditioning compressor 40 is added, but all other components and the connection relationships between each component are the same as the second embodiment, so a detailed description of the configuration and operation is omitted.

The air conditioning compressor 40 may provide optimal air conditioning performance by utilizing the torque of the second motor MG2 when the vehicle is stopped, driving, charging, or at the P signal position of the shift lever.

The compressor 40 may be configured to operate in the region where the rotation speed and output torque of the second motor MG2 are optimal when the power disconnector 10 is turned off, but does not rotate to a high rotation speed corresponding to the maximum vehicle speed, so that it may be configured as a relatively low-cost type without high performance, and a variable capacity type or electron clutch type compressor that may be adjusted by the existing driver may be applied.

In the driving apparatus for an electric vehicle applied as a main or auxiliary driving source, even when the vehicle is stopped, charged, or driven at low speed, if there is a demand for operation of the compressor 40, the power disconnection device DC may be always maintained in an operating state, and the compressor 40 may be driven by the torque of the second motor MG2 to provide optimal air conditioning performance.

Meanwhile, during normal driving excluding the driving conditions above, if the required driving torque of the vehicle requires the driving torque of the second motor MG2, and the sum of the converted output torque of the second motor MG2 required as the required driving torque of the vehicle and the driver torque of the compressor 40 is less than the maximum output torque of the second motor MG2 while power disconnection device DC is operating, the driving performance of the vehicle may be secured by the sum of the required driving torque of the second motor MG2, and at the same time, the compressor 40 may be normally operated by the residual driving torque of the second motor MG2 at the rotation speed corresponding to the vehicle speed.

If the sum of the converted output torque of the second motor MG2 required as the required driving torque of the vehicle and the driver torque of the compressor 40 exceeds the maximum output torque of the second motor MG2, or if the required driving torque of the vehicle requires almost all of the converted output torque of the second motor MG2, the compressor 40 may be operated at the lowest performance level to secure the driving performance of the vehicle as a top priority, or the operation of the compressor 40 may be stopped by electronically controlling the power connector 30.

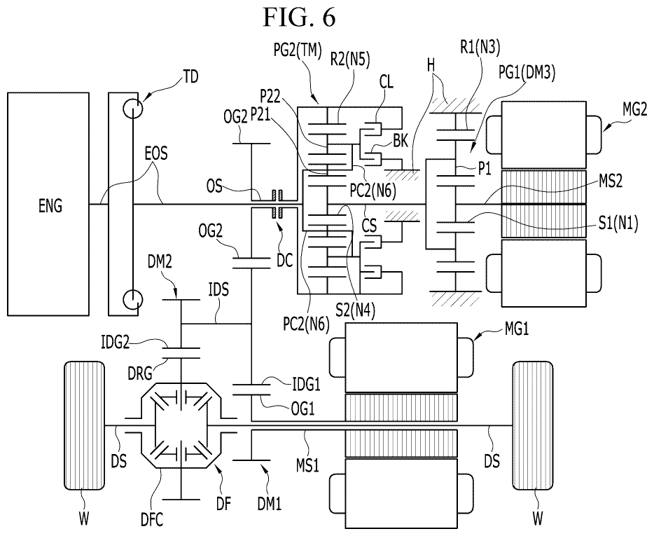

FIG. 6 is a schematic diagram of a driving apparatus for an electric vehicle according to the sixth embodiment of the present disclosure.

For convenience of understanding, when explaining the driving apparatus for an electric vehicle according to the sixth embodiment of the present disclosure, the same components as those of the driving apparatus for an electric vehicle according to the third embodiment of the present disclosure described above is given the same reference numerals. In addition, when explaining the driving apparatus for an electric vehicle according to the sixth embodiment of the present disclosure, an overlapped explanation of the configuration and operation of the same components as those of the driving apparatus for an electric vehicle according to the third embodiment of the present disclosure is omitted.

Referring to FIG. 6, the driving apparatus according to the sixth embodiment of the present disclosure may have a difference in the configuration in which an engine ENG is connected to the sixth rotation element N6 of the transmission device TM through an engine output shaft EOS compared to the third embodiment.

The engine ENG may configure a torsion damper TD on the engine output shaft EOS to absorb rotational impact.

The driving apparatus according to the sixth embodiment of the present disclosure may differ from the third embodiment in that the engine ENG is additionally configured, but all other components and the connection relationships between each component are the same as the third embodiment, so a detailed description of the configuration is omitted.

By adding the engine ENG, it is possible to develop hybrid, plug-in hybrid, travel distance extended electric vehicle (HEV/PHEV/EREV) and may be expanded to all vehicle types of front wheel or rear wheel 2WD drive type, 4WD (or AWD) drive type. In the sixth embodiment of the present disclosure, the engine ENG and the torsion damper TD may be positioned outside the housing H, and the engine output shaft EOS of the engine ENG may be engaged (or directly engaged) with the second planetary carrier PC2 of the transmission device TM.

The engine ENG may be equipped with a conventional starter (or starting motor), and the starting of the engine ENG may be implemented in two ways, for example, by the torque of the starter or the second motor MG2, depending on the actual driving condition of the vehicle or a predetermined driving mode by the driver.

The driving apparatus according to the sixth embodiment of the present disclosure may improve fuel efficiency performance by using the EV mode by the first motor MG1 when driving in a city, urban area, or congested suburban road with a lot of low rotation and low load driving, which is a region disadvantageous in terms of engine ENG efficiency (or poor fuel efficiency), and may secure silence and acceleration as a priority.

In addition, if the battery charge is sufficient, the power disconnection device DC may be operated and controlled in high-load regions such as merging at high speeds, abrupt acceleration, and hill climbing, thereby realizing EV mode by the combined electric power of the first and second motors MG1 and MG2, thereby simultaneously securing sufficient driving torque and improving acceleration performance.

On the other hand, when the battery charge decreases or becomes insufficient, the electrical energy of the battery may be used primarily for engine starting, and after starting engine, the second motor MG2 may be driven to generate power to charge the battery, while the series hybrid drive mode that enables continuous EV mode driving by the first motor MG1 and long-distance driving may be switched.

In addition, with the power disconnection device DC in operation control, it is possible to drive in a parallel hybrid drive mode that may use the torque of the first motor MG1 and the driving torque of the engine ENG together depending on the driving region of the vehicle.

In addition, it can be switched to a power split hybrid drive mode that supplies the driving torque of the engine ENG to the first and second motors MG1 and MG2 to contribute to vehicle driving.

In addition, in a high-speed cruise region or high-speed driving where engine driving is advantageous (or fuel efficiency is good), the engine may be connected (or directly connected) to the first, second reduction mechanisms DM1 and DM2 and the transmission device TM to realize a high-efficiency engine drive mode in which driving torque is connected (or directly connected) to the engine ENG.

The first, the second motor MG1, and MG2 may contribute to improving the fuel efficiency performance of the engine ENG by allowing the surplus driving torque of the engine ENG other than the driver's required torque to be used for battery charging, or by supporting the insufficient driving torque, such as in a parallel hybrid driving mode, when high power is momentarily required.

In addition, in a high-load region of the vehicle, or when explosive acceleration or full power is required during driving, the power disconnection device DC may switch to a power boost drive mode (Power Boost Hybrid Drive Mode) in which the driving torque of the engine ENG and the combined torque of the first and second motors MG1 and MG2 may be simultaneously transmitted to the wheels while in the operating state.

Meanwhile, when the power disconnection device DC is turned off, the battery may be continuously charged using the engine ENG at any time while the vehicle is stopped, similar to the serial hybrid driving mode.

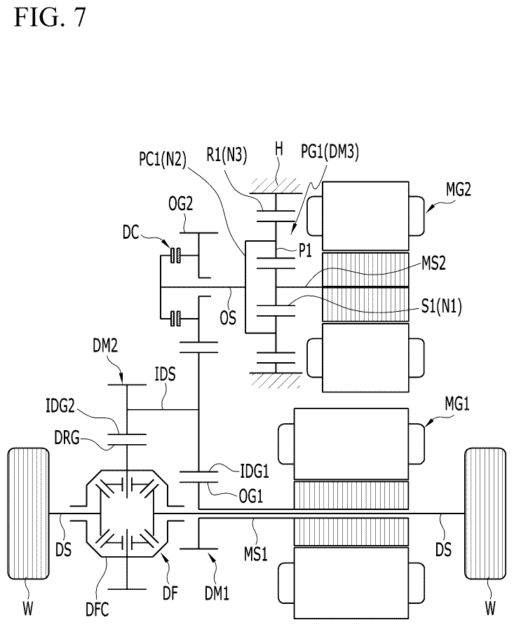

FIG. 7 is a schematic diagram of a driving apparatus for an electric vehicle according to the seventh embodiment of the present disclosure.

For convenience of understanding, when explaining the driving apparatus for an electric vehicle according to the seventh embodiment of the present disclosure, the same components as those of the driving apparatus for an electric vehicle according to the first embodiment of the present disclosure is given the same reference numerals. In addition, when explaining the driving apparatus for an electric vehicle according to the seventh embodiment of the present disclosure, a overlapped explanation of the configuration and operation of the same components as those of the driving apparatus for an electric vehicle according to the first embodiment of the present disclosure is omitted.

Referring to FIG. 7, the driving apparatus according to the seventh embodiment of the present disclosure may have a difference, compared to the first embodiment, in that the output shaft OS is fixedly connected to the output side of the third reduction mechanism DM3, and the second output gear OG2 may be rotatably arranged on the output shaft OS, so that the output shaft OS and the second output gear OG2 are selectively connected through a power disconnection device DC.

The driving apparatus according to the first embodiment of the present disclosure may be configured such that the output shaft OS and the third reduction mechanism DM3 are selectively connected via the power disconnection device DC, whereas the driving apparatus according to the seventh embodiment of the present disclosure is configured such that the output shaft OS is connected to the second rotation element N2 of the third reduction mechanism DM3, and the second output gear OG2 is rotatably arranged on the output shaft OS so that the second output gear OG2 is selectively connected to the output shaft OS via the power disconnection device DC.

The driving apparatus according to the seventh embodiment of the present disclosure may differ only in the connection relationship of the output shaft OS, the second output gear OG2, and the power disconnection device DC compared to the first embodiment, and all other components and the connection relationship and operation of each component are the same as the first embodiment, so a detailed description of the configuration and operation is omitted.

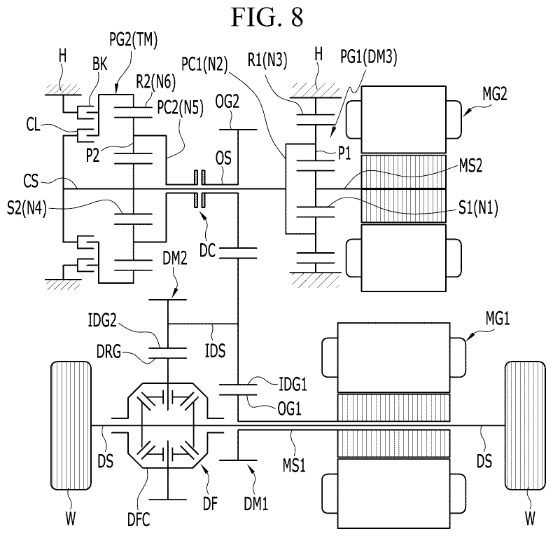

FIG. 8 is a schematic diagram of a driving apparatus for an electric vehicle according to the eighth embodiment of the present disclosure.

For convenience of understanding, when explaining the driving apparatus for an electric vehicle according to the eighth embodiment of the present disclosure, the same components as those of the driving apparatus for an electric vehicle according to the seventh embodiment of the present disclosure described above is given the same reference numerals. In addition, when explaining the driving apparatus for an electric vehicle according to the eighth embodiment of the present disclosure, an overlapped explanation of the configuration and operation of the same components as those of the driving apparatus for an electric vehicle according to the seventh embodiment of the present disclosure is omitted.

Referring to FIG. 8, the driving apparatus according to the eighth embodiment of the present disclosure may differ from the seventh embodiment in that a middle shaft CS is added and a transmission device TM is additionally configured on the middle shaft CS.

The driving apparatus according to the seventh embodiment of the present disclosure may be configured to selectively transmit the torque of the second motor MG2 to the second output gear OG2 by selectively connecting the output shaft OS to the second output gear OG2 through the power disconnection device DC.

On the other hand, the driving apparatus according to the eighth embodiment of the present disclosure further may include the transmission device TM that selectively shifts the torque of the second motor MG2, whose rotation speed is reduced and output from the third reduction mechanism DM3, into two shift stages and outputs the shifted torque, and the shifted torque may be selectively transmitted to the output shaft OS through the power disconnection device DC.

The output shaft OS may be formed as a hollow shaft, and the middle shaft CS may be arranged to penetrate the output shaft OS and may be connected to the second rotation element N2 of the third reduction mechanism DM3.

The transmission device TM may be a second planetary gear set PG2 having fourth, fifth, sixth rotation elements N4, N5, and N6, and may be coaxially arranged with the middle shaft CS on the opposite side of the third reduction mechanism DM3 with the first reduction mechanism DM1 as reference.

The transmission device TM may be configured to selectively shift the input torque through the third reduction mechanism DM3 from the second motor MG2 into two shift stages and output the input torque to the output shaft OS side.

The fourth rotation element N4 may be connected to the middle shaft CS and operates as an input element, the fifth rotation element N5 may be selectively connected to the output shaft OS via the power disconnection device DC and operates as an output element, and the sixth rotation element N6 may be selectively connected to the fourth rotation element N4 or the housing H and operates as an input element or a fixed element.

In the transmission device TM, the fourth rotation element N4 may be connected to the middle shaft CS and operate as an input element, the fifth rotation element N5 may be selectively connected to the output shaft OS through the power disconnection device DC and operates as an output element, and the sixth rotation element N6 may be selectively connected to the fourth rotation element N4 or housing H and operate as an input element or a fixed element.

The transmission device TM may include a clutch CL interposed between the second sun gear S2, which is the fourth rotation element N4, and the second ring gear R2, which is the sixth rotation element N6, to selectively connect the fourth rotation element N4 and the sixth rotation element N6, and a brake BK interposed between the sixth rotation element N6 and the housing H to selectively connect the sixth rotation element N6 to the housing H.

The clutch CL may interconnect the fourth rotation element N4 and the sixth rotation element N6 so that the second planetary gear set PG2 itself rotates as a single rotation body, and the brake BK may fix the sixth rotation element N6 so that the second ring gear R2 acts as a fixed element.

The driving apparatus according to the eighth embodiment of the present disclosure may differ from the seventh embodiment in that the middle shaft CS and the transmission device TM are additionally configured, but all other components and the connection relationships between each component are the same as those in the first embodiment, so a detailed description of the configuration is omitted.

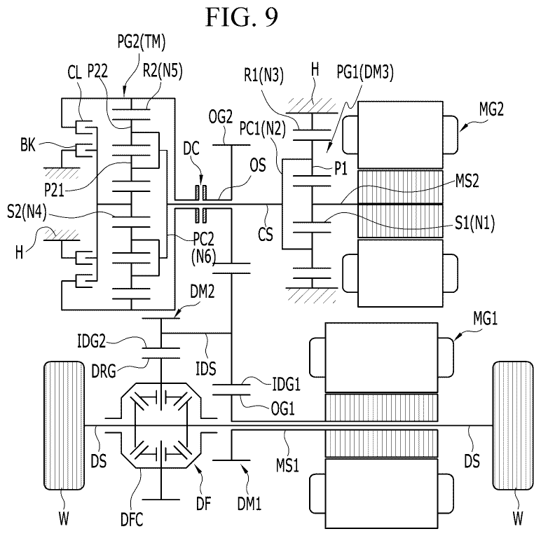

FIG. 9 is a schematic diagram of a driving apparatus for an electric vehicle according to the ninth embodiment of the present disclosure.

For convenience of understanding, when explaining the driving apparatus for an electric vehicle according to the ninth embodiment of the present disclosure, the same components as those of the driving apparatus for an electric vehicle according to the eighth embodiment of the present disclosure is given the same reference numerals. In addition, when explaining the driving apparatus for an electric vehicle according to the ninth embodiment of the present disclosure, a overlapped explanation of the configuration and operation of the same components as those of the driving apparatus for an electric vehicle according to the eighth embodiment of the present disclosure is omitted.

Referring to FIG. 9, the driving apparatus according to the ninth embodiment of the present disclosure may have a difference in the configuration of the second planetary gear set PG2 applied to the transmission device TM compared to the eighth embodiment.

The driving apparatus according to the eighth embodiment of the present disclosure may be applied with the second planetary gear set PG2 applied to the transmission device TM as a single pinion planetary gear set. However, the driving apparatus according to the ninth embodiment of the present disclosure may have a difference in that the second planetary gear set PG2 applied to the transmission device TM is applied as a double pinion planetary gear set.

The transmission device TM applied to the driving apparatus according to the ninth embodiment of the present disclosure may include a second planetary gear set PG2 formed by a double pinion planetary gear set and having fourth, fifth, sixth rotation elements N4, N5, and N6, coaxially arranged with the middle shaft CS, and configured to selectively shift the torque of the second motor MG2, whose rotation speed is reduced and output from the third reduction mechanism DM3, into two shift stages and outputs the shifted torque, and the shifted torque may be selectively transmitted to the output shaft OS through the power disconnection device DC.

The sixth rotation element N6 may be connected to the middle shaft CS and operate as an input element, the fifth rotation element N5 may be selectively connected to the output shaft OS and operate as an output element, and the fourth rotation element N6 may be selectively connected to the fifth rotation element N5 or housing H and operate as an input element or a fixed element.

The second planetary gear set PG2 of the transmission device TM as a double pinion planetary gear set may include a second sun gear S2 as the fourth rotation element N4, a second ring gear R2 as the fifth rotation element N5 arranged on an exterior circumference side of the second sun gear S2, and a second planetary carrier PC2 as the sixth rotation element N6 that supports rotation and revolution of a plurality of second double pinion gears P21 and P22 that are equally spaced between the second sun gear S2 and the second ring gear R2 and are externally and internally engaged with the second sun gear S2 and the second ring gear R2, respectively.

The transmission device TM may include a clutch CL interposed between the second sun gear S2, which is the fourth rotation element N4, and the second ring gear R2, which is the fifth rotation element N5, to selectively connect the fourth rotation element N4 and the fifth rotation element N5, and a brake BK interposed between the fourth rotation element N4 and the housing H to selectively connect the fourth rotation element N4 to the housing H.

The clutch CL may connect the fourth rotation element N4 and the fifth rotation element N5 to each other so that the second planetary gear set PG2 itself rotates as a single rotation body, and the brake BK may fix the fourth rotation element N4 so that it acts as a fixed element.

The driving apparatus according to the ninth embodiment of the present disclosure may have a difference in the configuration of the transmission device TM compared to the eighth embodiment, but all other components and the connection relationship and operation of each component are the same as the eighth embodiment, so a detailed description of the configuration and operation is omitted.

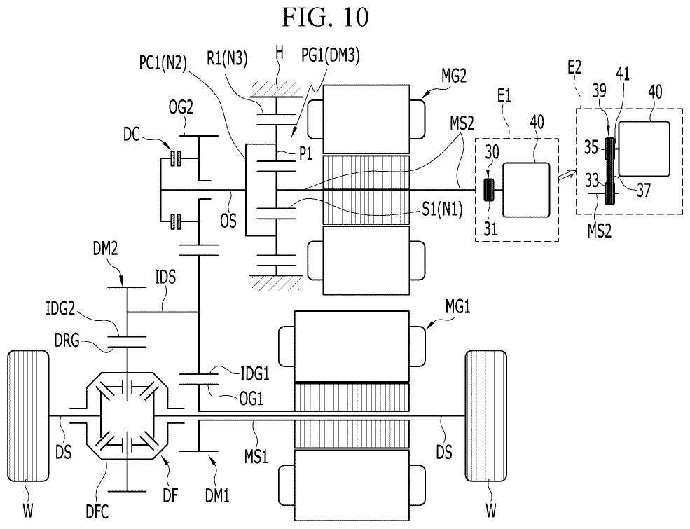

FIG. 10 is a schematic diagram of a driving apparatus for an electric vehicle according to the tenth embodiment of the present disclosure.

For convenience of understanding, when explaining the driving apparatus for an electric vehicle according to the tenth embodiment of the present disclosure, the same components as those of the driving apparatus for an electric vehicle according to the seventh embodiment of the present disclosure described above is given the same reference numerals. In addition, when explaining the driving apparatus for an electric vehicle according to the tenth embodiment of the present disclosure, an overlapped explanation of the configuration and operation of the same components as those of the driving apparatus for an electric vehicle according to the seventh embodiment of the present disclosure is omitted.

Referring to FIG. 10, the driving apparatus according to the tenth embodiment of the present disclosure may have a difference compared to the seventh embodiment in that an air conditioning compressor 40 capable of being power-connected to the output shaft OS through a power connector 30 is added.

The driving apparatus according to the tenth embodiment of the present disclosure may differ from the seventh embodiment in that an air conditioning compressor 40 is added, but other than this, all other components and the connection relationship between each component are the same as the seventh embodiment, and the operation is the same as the fourth embodiment, so a detailed description of the configuration and operation is omitted.

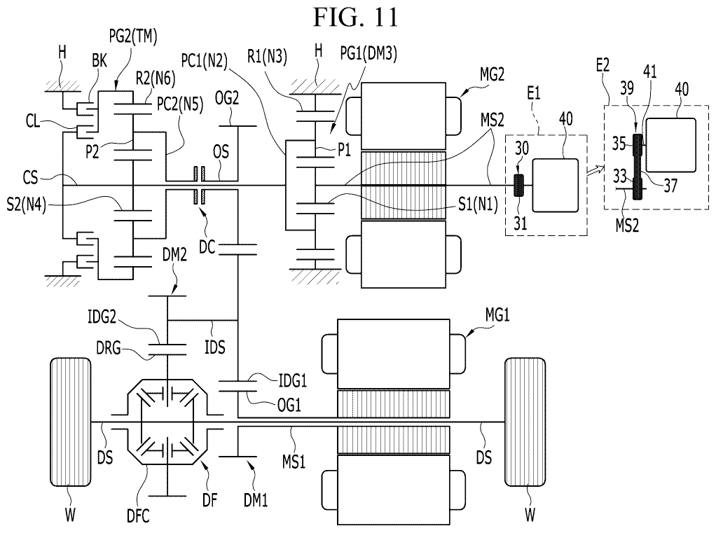

FIG. 11 is a schematic diagram of a driving apparatus for an electric vehicle according to the eleventh embodiment of the present disclosure.

For convenience of understanding, when explaining the driving apparatus for an electric vehicle according to the eleventh embodiment of the present disclosure, the same components as those of the driving apparatus for an electric vehicle according to the eighth embodiment of the present disclosure described above is given the same reference numerals. In addition, when explaining the driving apparatus for an electric vehicle according to the eleventh embodiment of the present disclosure, a overlapped explanation of the configuration and operation of the same components as those of the driving apparatus for an electric vehicle according to the eighth embodiment of the present disclosure is omitted.

Referring to FIG. 11, the driving apparatus according to the eleventh embodiment of the present disclosure may have a difference compared to the eighth embodiment in that an air conditioning compressor 40 capable of being power-connected to the second motor shaft MS2 of the second motor MG2 a power connector 30 is added.

The driving apparatus according to the eleventh embodiment of the present disclosure may differ from the eighth embodiment in that the air conditioning compressor 40 is added, but other than this, all other components and the connection relationship between each component are the same as the eighth embodiment, and the operation is the same as the fifth embodiment, so a detailed description of the configuration and operation is omitted.

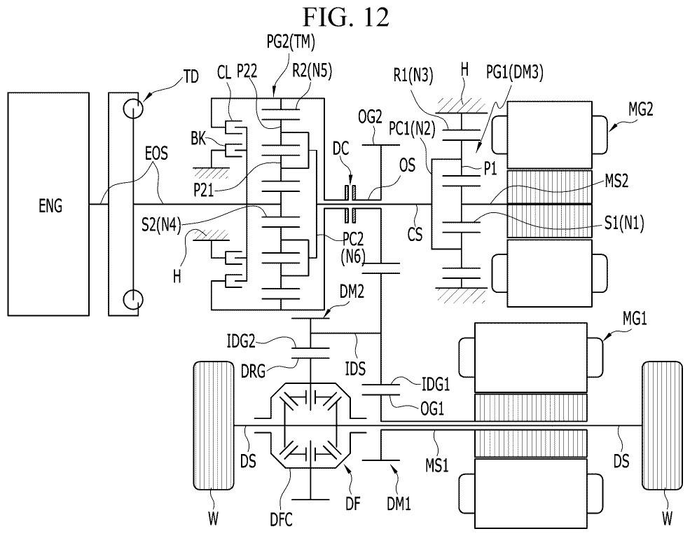

FIG. 12 is a schematic diagram of a driving apparatus for an electric vehicle according to the twelfth embodiment of the present disclosure.

For convenience of understanding, when describing a driving apparatus for an electric vehicle according to the twelfth embodiment of the present disclosure, the same components as those described above in the driving apparatus for an electric vehicle according to the ninth embodiment of the present disclosure is given the same reference numerals. In addition, when explaining the driving apparatus for an electric vehicle according to the twelfth embodiment of the present disclosure, an overlapped explanation of the configuration and operation of the same components as those of the driving apparatus for an electric vehicle according to the ninth embodiment of the present disclosure is omitted.

Referring to FIG. 12, the driving apparatus according to the twelfth embodiment of the present disclosure may have a difference in the configuration in that an engine ENG is connected to the sixth rotation element N6 of the transmission device TM through an engine output shaft EOS compared to the ninth embodiment.

The engine ENG may configure a torsion damper TD on the engine output shaft EOS to absorb rotational impact.

The driving apparatus according to the twelfth embodiment of the present disclosure may differ from the ninth embodiment in that the engine ENG is additionally configured, but all other components and the connection relationship between each component are the same as those of the ninth embodiment, and the operation may be the same as that of the sixth embodiment, so a detailed description of the configuration and operation is omitted.

The driving apparatus according to the first to twelfth embodiment of the present disclosure may operate by combining the first and second motors and the first, second and third reduction mechanisms and so that they may appropriately perform their roles in each driving region of the electric vehicle, thereby increasing the driving torque and improving the acceleration performance during starting and low-speed driving, and improving the fuel efficiency of the electric vehicle by driving in the efficient driving point section of the motor.

In addition, the driving apparatus for an electric vehicle according to one or more embodiments combines the power disconnection device that blocks the torque of the second motor, which is an auxiliary driving source, and the transmission device that may add a reduction ratio by shifting the torque to two gears, thereby increasing efficiency gain and driving efficiency in relation to cost even if the required performance specifications increase.

In addition, the driving apparatus for an electric vehicle according to one or more embodiments configures the air conditioning compressor that is driven by the torque of the second motor, so that it may be driven with high efficiency according to driving conditions such as stopping, driving, charging, or parking of the vehicle, thereby providing optimal air conditioning performance.

In addition, the driving apparatus for an electric vehicle according to one or more embodiments may be combined as a hybrid electric vehicle by mounting the engine in the power delivery path of the second motor, which is the auxiliary driving source, so that the travel distance may be expanded, and in the development of an electric vehicle, it has the effect of being able to expand to all vehicle types, such as a 2WD driving method with front wheel or rear wheel drive and a 4WD driving method.

Although the preferred embodiments of the present disclosure have been described above, the present disclosure is not limited thereto, and various modifications may be made within the scope of the claims, the detailed description of the invention, and the attached drawings, which also fall within the scope of the present disclosure.

What is claimed is:

1. A driving apparatus for an electric vehicle, the driving apparatus comprising:
a first motor arranged on both sides of a drive shaft, which connects a differential to wheels and transmits driving torque to the wheels, wherein the first motor includes a first motor shaft of a hollow shaft arranged to overlap the drive shaft;
a second motor arranged parallel to the first motor and including a second motor shaft;
an output shaft coaxially arranged with the second motor shaft of the second motor;
an idle shaft arranged parallel between the first motor shaft of the first motor and the second motor shaft of the second motor;
a first reduction mechanism including a first output gear fixed to the first motor shaft, a second output gear on the output shaft, and a first idle gear fixed to a first side of the idle shaft and externally engaged with the first and second output gears;
a second reduction mechanism including a second idle gear fixed to a second side of the idle shaft and a differential ring gear of the differential which is externally engaged with the second idle gear;
a third reduction mechanism including a first planetary gear set having first, second, and third rotation elements and arranged on the second motor shaft, wherein the third reduction mechanism is configured to reduce the rotation speed of the torque input from the second motor and output the rotation speed of the torque input to the output shaft; and
a power disconnection device interposed between the first reduction mechanism and the third reduction mechanism and configured to selectively connect the torque of the second motor transmitted from the third reduction mechanism to the first reduction mechanism.

2. The driving apparatus of claim 1, wherein
the second output gear is fixed to a first side of the output shaft, and the output shaft is selectively connected to an output side of the third reduction mechanism through the power disconnection device.

3. The driving apparatus of claim 2, wherein
the first rotation element is connected to the second motor shaft and configured to operate as an input element, the second rotation element is selectively connected to the output shaft and configured to operate as an output element, and the third rotation element is fixedly attached to a housing and configured to operate as a fixed element.

4. The driving apparatus of claim 3, wherein
the first planetary gear set is a single pinion planetary gear set including a first sun gear, which is the first rotation element, a first planetary carrier which is the second rotation element, and a first ring gear, which is the third rotation element.

5. The driving apparatus of claim 3, wherein
the power disconnection device is disposed on the output shaft and is configured to selectively connect the output shaft to the second rotation element of the first planetary gear set.

6. The driving apparatus of claim 2, further comprising:
a middle shaft disposed on the output shaft which is disposed between the first reduction mechanism and the third reduction mechanism and connected to an output side of the third reduction mechanism; and
a transmission device which is a second planetary gear set disposed on the middle shaft, including fourth, fifth, and sixth rotation elements, and selectively shifting an input torque through the third reduction mechanism from the second motor into two shift stages.

7. The driving apparatus of claim 6, wherein
the fourth rotation element is connected to the middle shaft and operates as an input element, the fifth rotation element is selectively connected to the output shaft through the power disconnection device and operates as an output element, and the sixth rotation element is selectively connected to between the fourth rotation element and a housing and operates as the input element or a fixed element.

8. The driving apparatus of claim 7, wherein the transmission device further includes:
a clutch interposed between the fourth rotation element and the sixth rotation element and selectively connecting the fourth rotation element to the sixth rotation element; and
a brake interposed between the sixth rotation element and the housing to selectively connect the sixth rotation element to the housing.

9. The driving apparatus of claim 7, wherein
the second planetary gear set is a single pinion planetary gear set including a second sun gear which is the fourth rotation element, a second planetary carrier which is the fifth rotation element, and a second ring gear which is the sixth rotation element.

10. The driving apparatus of claim 6, wherein
the fourth rotation element is connected to the middle shaft and operates as an input element, the fifth rotation element is selectively connected to the output shaft and operates as an output element, and the sixth rotation element is selectively connected to between the fifth rotation element and a housing and operates as the input element or a fixed element.

11. The driving apparatus of claim 10, wherein the transmission device further includes:
a clutch disposed between the fifth rotation element and the sixth rotation element and configured to selectively connect the fifth rotation element to the sixth rotation element; and
a brake disposed between the sixth rotation element and the housing and configured to selectively connect the sixth rotation element to the housing.

12. The driving apparatus of claim 10, wherein
the second planetary gear set is a double pinion planetary gear set including a second sun gear which is the fourth rotation element, a second ring gear which is the fifth rotation element, and a second planetary carrier which is the sixth rotation element.

13. The driving apparatus of claim 10, further comprising:
an engine connected to the sixth rotation element of the transmission device through an engine output shaft.

14. The driving apparatus of claim 1, wherein the output shaft is fixedly connected to an output side of the third reduction mechanism, the second output gear is rotatably arranged on one side of the output shaft, and the output shaft is selectively connected to the second output gear through the power disconnection device.

15. The driving apparatus of claim 14, wherein
the first rotation element is connected to the second motor shaft and operates as an input element, the second rotation element is connected to the output shaft and operates as an output element, and the third rotation element is fixedly attached to a housing and operates as a fixed element.

16. The driving apparatus of claim 15, wherein
the power disconnection device is disposed between the output shaft and the second output gear to selectively connect the output shaft to the second output gear.

17. The driving apparatus of claim 14, further comprising:
a middle shaft arranged through the output shaft which is formed as a hollow shaft and connected to the output side of the third reduction mechanism; and
a transmission device as a second planetary gear set including fourth, fifth, sixth rotation elements and coaxially arranged with the middle shaft on an opposite side of the third reduction mechanism with the first reduction mechanism as reference.

18. The driving apparatus of claim 17, wherein
the fourth rotation element is connected to the middle shaft and operates as an input element, the fifth rotation element is selectively connected to the output shaft and operates as an output element, and the sixth rotation element is selectively connected to between the fourth rotation element and the housing and operates as the input element or a fixed element.

19. The driving apparatus of claim 17, wherein
the sixth rotation element is connected to the middle shaft and operates as an input element, the fifth rotation element is selectively connected to the output shaft and operates as an output element, and the fourth rotation element is selectively connected to between the fifth rotation element and the housing and operates as the input element or a fixed element.

20. The driving apparatus of claim 19, further comprising:
an engine connected to the fourth rotation element of the transmission device through an engine output shaft.
